(19) United States
(12) Patent Application Publication
(10) Pub. No.: US 2016/0059056 A1
(43) Pub. Date: Mar. 3, 2016

(54) Methods and Apparatus for Fire Suppressant Panel

(71) Applicant: FIRETRACE USA, LLC, Scottsdale, AZ (US)

(72) Inventor: William David Hoffman, III, Cave Creek, AZ (US)

(21) Appl. No.: 14/838,619

(22) Filed: Aug. 28, 2015

Related U.S. Application Data
(60) Provisional application No. 62/042,930, filed on Aug. 28, 2014.

(51) Int. Cl. A62C 3/00; A62C 35/10

(52) U.S. Cl. CPC A62C 3/002; A62C 35/10

(57) ABSTRACT

A fire suppressant panel according to various aspects of the present technology is configured to deliver a fire suppressant material in response to a detected fire condition in a transportable container. In one embodiment, the fire suppressant panel comprises a housing having a heat sensitive detection tube disposed on one side of the housing. The heat sensitive detection tube is adapted to release a fire suppressant material in response to being exposed to a fire condition.

### CROSS-REFERENCES TO RELATED APPLICATIONS

This application claims the benefit of U.S. Provisional Patent Application No. 62/042,930, filed Aug. 28, 2014, and incorporates the disclosure of the application by reference.

### BACKGROUND OF THE TECHNOLOGY

Bulk shipment of certain types of items may present a hazard to containers and transportation vehicles hauling the containers within the shipping industry. For example, a lithium ion battery may experience thermal runaway, a process in which an elevated temperature of the battery may cause an exothermic reaction creating a closed loop process where the temperature of the battery may continually increase until the battery ignites. This ignition may create a catastrophic fire event that can rapidly spread to other batteries stored in the same bulk container, other containers stored near the ignited battery, or the transportation vehicle itself. Depending on the type of transportation vehicle, an increased safety risk to the vehicle and operators may be created. For example, bulk shipping products susceptible to thermal runaway by air transport may present a safety risk that is too high to allow the aircraft to transport the products absent some system or device to help mitigate the potential for a spontaneous fire condition.

### SUMMARY OF THE TECHNOLOGY

A fire suppressant panel according to various aspects of the present technology is configured to deliver a fire suppressant material in response to a detected fire condition in a transportable container. In one embodiment, the fire suppressant panel comprises a housing having a heat sensitive detection tube disposed on one side of the housing. The heat sensitive detection tube is adapted to release a fire suppressant material in response to being exposed to a fire condition.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates a fire suppressant panel and a shipping container in accordance with an exemplary embodiment of the present technology;

FIG. 2 representatively illustrates a detailed view of the fire suppressant panel in accordance with an exemplary embodiment of the present technology;

FIG. 3 representatively illustrates a detection tube positioned in the fire suppressant panel in accordance with an exemplary embodiment of the present technology;

FIG. 4 representatively illustrates a burst detection tube in accordance with an exemplary embodiment of the present technology; and

FIG. 5 representatively illustrates an alternative embodiment of the fire suppressant panel in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various hazardous materials, hazard control materials, container materials, pressurizations, dimensions, and geometries, which may carry out a variety of operations suited to a specified hazard condition, application, or environment. In addition, the present technology may be practiced in conjunction with any number of systems configured for operation with the hazardous material and/or hazard control material, and the system described is merely one exemplary application for the technology. Further, the present technology may employ any number of conventional techniques for hazard control, hazard prevention, risk reduction, and the like.

The present technology may be described herein in terms of functional block components and various processing steps. Such functional blocks may be realized by any number of hardware components configured to perform the specified functions and achieve the various results. For example, the present technology may employ various housings, panels, connectors, sensors, and the like, which may carry out a variety of functions. In addition, the present technology may be practiced in conjunction with any number of structures, buildings, containers, and/or vehicles such as trucks, fixed wing aircraft, rotorcraft, and water crafts, and the system described is merely one exemplary application for the technology. Further, the present technology may employ any number of conventional techniques for suppressing fire, sensing environmental conditions, and the like.

Methods and apparatus for a fire suppressant panel according to various aspects of the present technology may operate in conjunction with any container and/or receptacle such as that used to transport or ship items such as batteries containing caustic or flammable fluids, combustible chemicals, ammunition, and the like. Various representative implementations of the present technology may be applied to any container and/or receptacle that may be used for any items that may be subject to combustion during transport.

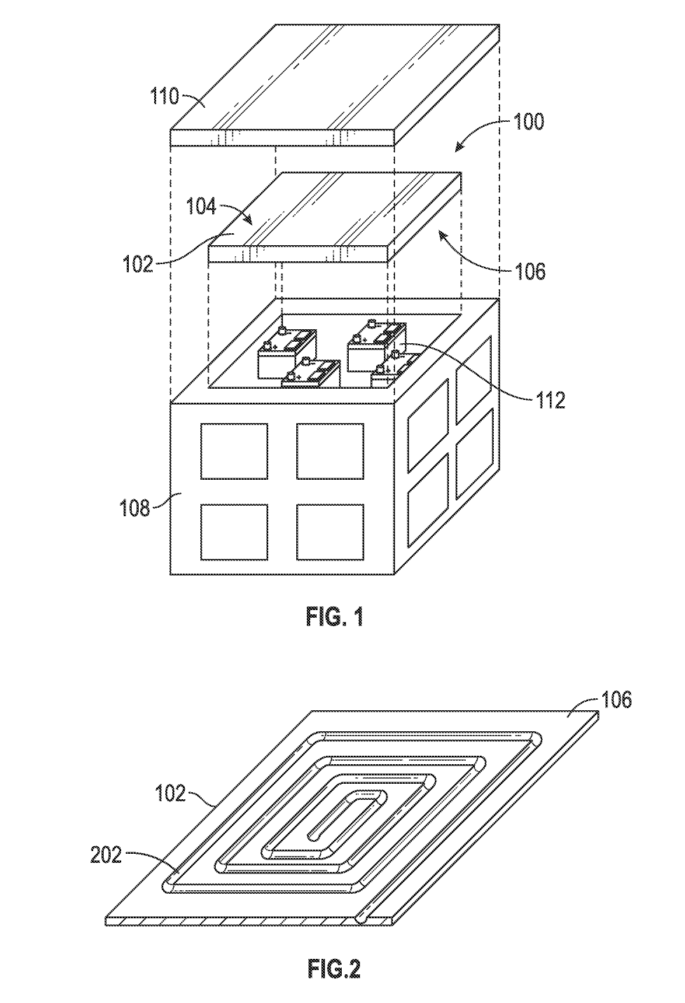

Referring to FIG. 1, a fire suppressant panel 100 may comprise a housing 102 having an upper surface 104 and a lower surface 106. The housing 102 may be suitably configured to be positioned within an open topped shipping container 108 and above any items 112 stored within the shipping container 108. A cover 110 may be positioned over the shipping container 108 to seal or otherwise enclose the housing 102 and the items 112 inside of the shipping container 108.

The shipping container 108 houses the items 112 during shipment and may comprise any suitable device or system for holding or securing cargo. In one embodiment, the shipping container 108 may comprise a standardized shipping unit having dimensions of about twenty-four inches wide by about twenty-four inches long and up to about thirty inches in height. Alternatively, the shipping container 108 may comprise any suitable dimension up to about forty-eight inches. The shipping container 108 may comprise any suitable material such as wood, plastic, or metal. The shipping container 108 may alternatively comprise a material adapted to be resistant to fire.

The cover 110 is used to fully enclose or seal the items 112 within an interior area of the shipping container 108. The cover 110 may comprise any suitable lid, panel, door, sheet, or the like that covers an interior area of the shipping container 108. The cover 110 may be configured to attach to the shipping container 108 or the cover 110 may be integrated into the shipping container itself. For example, in one embodiment, the cover 110 may comprise a lid suitably configured to be fit to the open top portion of the shipping container 108 and held in place by friction or by a mechanical fastener such as a clip, latch, buckle, screw, nail, or the like. In an alternative embodiment, the cover 110 may be fixed to the shipping container 108 by a hinge that is suitably configured to allow the cover 110 to rotate between an open and a closed position to provide access to the interior area of the shipping container 108.

The housing 102 is configured to fit within the shipping container 108 and is responsive to a fire condition and is configured to release a fire suppressant material in response to a detected fire condition. The housing 102 may comprise any suitable device or system that may be positioned within the shipping container 108 and disposed above the items 112 being transported in the shipping container 108. For example, the housing 102 may comprise a substantially rectangular panel having an upper surface 104 and a lower surface 106.

The housing 102 may comprise any suitable materials such as plastics, composites, wood, or metal. The housing 102 may also comprise fire-resistant or fire-retardant materials such as fabrics, plastics, metals, polymers, and the like and may be constructed as a single piece or may be formed from separately constructed sections or elements. The housing 102 may be formed as a rigid, semi-rigid, flexible, and/or malleable material and may comprise any suitable dimensions (i.e., length, width, height) depending on the type of shipping container 108 the housing 102 is intended to be used with. For example, for a shipping container 108 having interior dimensions of twenty-four inches by twenty-four inches, the housing 102 may comprise dimensions that would allow the housing 102 to fit within the interior and rest on top of the items 112. Alternatively, the housing may comprise dimensions greater than twenty-four inches on each side to allow the housing to rest against the top edges of the shipping container 108 such that the housing 102 is positioned above the items 112. For example, two or more edge portions of the housing 102 may comprise a flange configured to rest along the top edges of the shipping container 108 while allowing a center-portion of the housing 102 to be flush or slightly inset from the top of the shipping container 108. Referring now to FIG. 5, in yet another embodiment, the housing 102 may be integrated into an underside of the cover 110 to form a single unit.

Referring now to FIGS. 2-4, the lower surface 106 of the housing 102 may be configured to receive a fire detection and suppression system. For example, in one embodiment, a recessed channel or groove 202 may be formed in the lower surface 106 to allow a detection system 302 to be coupled to the housing 102. The groove 202 may comprise any suitable size or shape for receiving the fire detector 302. For example, the groove 202 may comprise a semi-circular recessed channel or a boxed recess having substantially vertical walls.

The detection system 302 senses the fire condition and releases the fire suppressant material. The detection system 302 may comprise any suitable device or system for detecting and releasing a fire suppressant such as a heat sensitive detection tube or a linear heat detector. The detection system 302 may be suitably configured to be positioned within the groove 202 and held in place by any suitable method such as a friction press fit or by a retaining mechanism 306 such as mechanical fasteners, adhesives, straps, clips, ties, hook and loop fasteners, magnets, compression fittings, and the like.

For example, in one representative embodiment, the detection system 302 may comprise a detection tube 304 configured to hold a fire suppressant material under a predetermined internal pressure until exposed to a trigger event such as exposure to flame, elevated ambient temperatures generally associated with a fire, or a particular energy level associated with a fire. Exposure of the detection tube 304 to the trigger event may cause the structural integrity of the detection tube 304 to degrade until the detection tube 304 leaks, bursts, or otherwise loses internal pressure. For example, an opening 402 in the detection tube 304 may result from the degradation in structural integrity at a location where the flames of the fire come into contact with the detection tube 304.

The detection tube 304 releases the fire suppressant material in response to the degradation in structural integrity. For example, when the detection tube 304 ruptures, the fire suppressant material may be ejected from or otherwise escape through the opening 402 such that the fire suppressant material is dispersed onto the fire. Accordingly, the fire suppressant material may be sealed within the heat sensitive pressure tube 140.

The detection tube 304 may comprise any appropriate materials that degrade when exposed to the trigger event, such as: Firetrace® detection tubing, aluminum, aluminum alloy, cement, ceramic, copper, copper alloy, composites, iron, iron alloy, nickel, nickel alloy, organic materials, polymer, titanium, titanium alloy, rubber, and the like. The detection tube 304 may be formed to any appropriate shape or dimension and may further comprise a coating resist corrosion, deformation, fracture, or other damage unrelated to the trigger event.

The internal pressure that the detection tube 304 is pressurized to may be determined by a temperature or energy level at which degradation of the tube is desired to occur. For example, the detection tube 304 may comprise a material that degrades differently when subjected to various combinations of ambient temperature and internal pressure thereby allowing a user to select what conditions must be met by the trigger condition. The detection tube 304 may demonstrate an inverse relationship between the internal pressure of the detection tube and the temperature that causes the detection tube to degrade, leak, and/or burst. For example, as the detection tube 304 is pressurized to a higher level the detection tube 304 may burst when exposed to a lower temperature. Alternatively, the detection tube 304 may demonstrate a direct relationship between the internal pressure of the detection tube 304 and the temperature that causes the detection tube 304 to degrade, leak, burst, or otherwise lose internal pressure.

The detection tube 304 may be pressurized with a higher or lower internal pressure than an ambient pressure in the interior area of the shipping container 108. The internal pressure of the detection tube 304 may be achieved and sustained in any suitable manner, such as by pressurizing and sealing both ends of the detection tube 304. The detection tube 304 may be pressurized with any fluid that is sensitive to changes in temperature or pressure. For example, a substantially inert fluid such as air, nitrogen, or argon may be used to pressurize the detection tube 304 to a predetermined internal pressure.

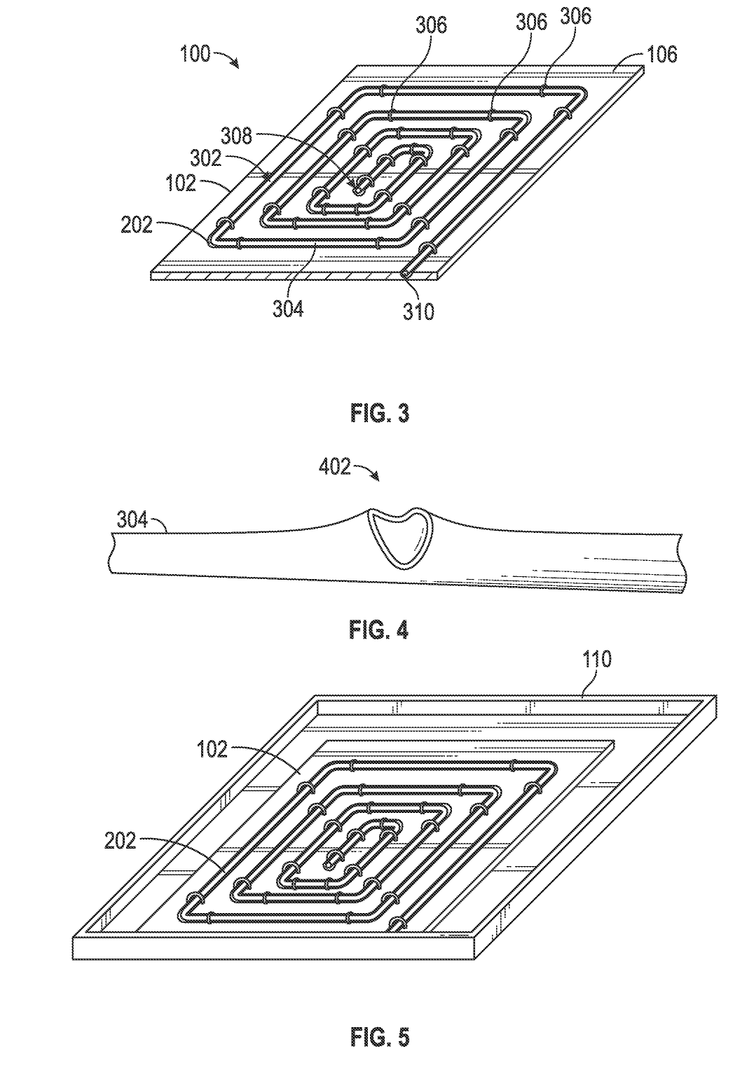

The detection tube 304 may also be configured to be sealed on each end while maintaining the predetermined internal pressure. The detection tube 304 may be sealed by any suitable method. For example, referring now to FIG. 3, a first end of the detection tube 308 may be sealed and a second end may be sealed at a termination point 310. The termination point 310 may also provide a location where the detection tube 304 may be pressurized. The termination point 310 may comprise any suitable method or device for sealing the detection tube 304, such as a plug, a pressure gauge, a schrader valve, or a presta valve.

The termination point 310 may further comprise an indicator configured to display an operational status of the fire suppressant panel 100. For example, the indicator may be adapted to display a green panel if the detection tube 304 is fully pressurized and functional to adequately suppress a fire condition, and a red display if the detection tube 304 is depressurized or otherwise in a condition that would indicate a compromised ability to adequately suppress a fire condition. In a second embodiment, the indicator may comprise a pressure gauge that is visible to a user and suitably configured to indicate the pressure within the detection tube 304. For example, the indicator may be placed on any suitable exterior surface of the housing 102 such that the internal pressure of the detection tube 304 may be viewed without having to remove the detection tube 304 from the housing 102.

The detection tube 304 may fit flush to the lower surface 106 or the heat detection tube 304 may extend slightly outward from the lower surface 106. The detection tube 304 may be routed along the lower surface 106 in any suitable configuration such as coils, loops, and/or the like according to desired design considerations such as corrosion, cost, the type of material sought to be protected, or the size of the shipping container 108.

The fire suppressant material may be selected according to the particular environment that the shipping container 108 will be used in. For example, if the fire suppressant panel 100 is configured to suppress a fire by maintaining a low oxygen level, the fire suppressant material may be selected from any suitable chemical or compound adapted to absorb or dilute oxygen levels when transmitted into the enclosed volume 110. As another example, if the fire suppressant panel 100 is configured to suppress a fire by inhibiting the chemical reaction of the fire, the fire suppressant material may be selected from an appropriate agent. In yet another embodiment, the fire suppressant material may be selected from materials adapted to suppress a fire by reducing the heat of the fire.

For example, one fire suppressant material may be suitably adapted for transient events such as explosions or other rapid combustion. Alternatively, the fire suppressant material may be suitably adapted to change from a liquid state inside of the detection tube 304 to a gaseous state when ejected into the shipping container 108. The fire suppressant material may alternatively comprise a common dry chemical suppressant such as ABC, BC, or D dry powder. In another embodiment, the fire suppressant material may comprise a fire suppressant mixture such as potassium acetate and water. In yet another embodiment, the hazard control material may comprise a suppressant material further comprising additional chemicals or compounds such as various forms or combinations of lithium, sodium, potassium, chloride, graphite, acetylene, oxides, and magnetite.

The fire suppressant material may also be adapted to have more than a single method of controlling the hazard. For example, the fire suppressant material may comprise multiple elements or compounds, wherein each compound has a different property such as being reactive or unreactive to heat, acting to deprive a fire of oxygen, absorbing heat radiated from the fire, and/or transferring heat from the fire to another compound.

These and other embodiments for methods of controlling a hazard may incorporate concepts, embodiments, and configurations as described with respect to embodiments of apparatus for controlling a hazard as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to a preferred embodiment. However, changes and modifications may be made to the preferred embodiment without departing from the scope of the present technology. These and other changes or modifications are intended to be included within the scope of the present technology, as expressed in the following claims.

1. A fire suppressant panel for a transportable shipping container having an internal receiving area and a cover, comprising:
a housing configured to be positioned between the internal receiving area and the cover of the transportable shipping container, wherein the housing comprises:
an upper surface configured to face the cover of the transportable container; and
a lower surface comprising a groove configured to face towards the internal receiving area;
a detection tube disposed within the groove, wherein the detection tube is:
filled with a fire suppressant material and held under a predetermined internal pressure; and
configured to rupture in response to exposure to a fire condition within the internal receiving area causing the release of the fire suppressant material into the internal receiving area.

2. The fire suppressant panel of claim 1, wherein the detection tube is secured to the groove by a press fit.

3. The fire suppressant panel of claim 1, wherein the detection tube is coupled to the groove by a retaining mechanism.

4. The fire suppressant panel of claim 3, wherein the retaining mechanism comprises a clip configured to fit around the detection tube and attach to the lower surface.

5. The fire suppressant panel of claim 1, further comprising an indicator coupled to the detection tube and configured to:
sense the internal pressure of the detection tube; and
display an indication of the sensed internal pressure.

6. The fire suppressant panel of claim 5, wherein the indicator is coupled to an end of the detection tube.

7. The fire suppressant panel of claim 5, wherein the indicator is positioned along a side of the housing.

8. The fire suppressant panel of claim 1, further comprising a valve coupled to an end of the detection tube and configured to allow the detection tube to be filled with suppressant and pressurized.

9. The fire suppressant panel of claim 1, wherein the detection tube does not project outward beyond the lower surface of the housing panel.

10. A fire suppressant panel for a transportable shipping container having an internal receiving area, comprising:
a cover configured to close off the internal receiving area;
a housing positioned along an underside of the cover, wherein the housing comprises a surface comprising a groove configured to face towards the internal receiving area;
a detection tube disposed within the groove, wherein the detection tube is:
filled with a fire suppressant material and held under a predetermined internal pressure; and
configured to rupture in response to exposure to a fire condition within the internal receiving area causing the release of the fire suppressant material into the internal receiving area.

11. The fire suppressant panel of claim 10, wherein the detection tube is secured to the groove by a press fit.

12. The fire suppressant panel of claim 10, wherein the detection tube is coupled to the groove by a retaining mechanism.

13. The fire suppressant panel of claim 12, wherein the retaining mechanism comprises a clip.

14. The fire suppressant panel of claim 10, further comprising an indicator coupled to the detection tube and configured to:
sense the internal pressure of the detection tube; and
display an indication of the sensed internal pressure.

15. The fire suppressant panel of claim 14, wherein the indicator is:
coupled to an end of the detection tube; and
positioned along a side of the cover.

16. The fire suppressant panel of claim 10, further comprising a valve coupled to an end of the detection tube and configured to allow the detection tube to be filled with suppressant and pressurized.

17. The fire suppressant panel of claim 10, wherein the detection tube does not project outward beyond the surface of the housing.
